(19) United States
(12) Patent Application Publication
(10) Pub. No.: US 2016/0081261 A1
(43) Pub. Date: Mar. 24, 2016

(54) Soil Cultivation Implement for Attachment to a Towing Vehicle

(71) Applicant: LEMKEN GMBH & CO. KG, Alpen (DE)

(72) Inventors: Georg Paulessen, Willich (DE); Sebastian Karsten, Xanten-Lüttingen (DE); Ludger Maas, Sonsbeck (DE); Georg Achten, Tönisvorst (DE); Christoph Happe, Alpen (DE)

(21) Appl. No.: 14/785,862

(22) PCT Filed: Apr. 17, 2014
(86) PCT No.: PCT/DE2014/000204

§ 371 Date: Oct. 21, 2015

(30) Foreign Application Priority Data
Apr. 24, 2013 (DE) 10 2013 007 038.4

(51) Int. Cl. A01B 63/02; A01B 73/02; A01B 49/02

(52) U.S. Cl. CPC A01B 63/02; A01B 49/027; A01B 73/02

(57) ABSTRACT

A soil cultivation implement 1 is proposed that is provided with a chassis 10 that supports a part of the weight of an additional soil cultivation device 6.

The invention describes a soil cultivation implement in accordance with the characterising clause of claim 1.

Soil cultivation implements of this type, as described, e.g., in patent application DE 10 201 0 054 946 A1, have increasingly greater weights, which have to be borne by the lifting device of the towing vehicle and which take the load off the latter's front axle and can thus impair the steering capability of the towing vehicle. Implements are familiar that support a part of the weight of the implement on the ground with the help of auxiliary chassis and thus take the load off the towing vehicle. In this case, the auxiliary chassis is lowered with hydraulic cylinders when the implement is transported and is lifted above the ground while the implement is working. The German disclosure DE 2 556 342 A1 describes such a device. Patent application DE10 224 861 A1 also has an auxiliary device for taking the weight off the towing vehicle as its object. Here, when the auxiliary chassis is lowered, only limited pressure is applied to the hydraulic cylinder in order not to overload the chassis on an uneven path. The German disclosure document DE 43 06 145 A1 shows a coupled soil cultivation implement that is attached with a tow bar to a reversible plough and can be steered. Patent applications EP 2 422 598 A2, DE 10 2009 014 874 A1 and DE 199 08 241 A1 each concern towed soil cultivation implements that are equipped with hydraulic chassis and with an additional soil cultivation device in the form of a pressing roller. A part of its weight is transferred indirectly to the pressing roller during work through the hydraulic operation of the chassis.

The task of the invention described below is to make a simple system available for improving the axle loads of the towing vehicle that does without expensive hydraulic components and can thus be manufactured at low cost and does not leave any ruts in the ground during operations. In addition, the machine operator is to be relieved of complicated operation procedures.

This task is solved in accordance with the invention by the characterising features of claim 1, whereby supplementary and alternative solutions are claimed advantageously in the additional patent claims.

As the chassis and the additional soil cultivation device, which are each supported on the base frame either pivoting or swivel-mounted, are moveably coupled to one another with a connecting element or link and thus form a moveable quadruple link, the chassis is raised above the ground in a lowered position and does not leave any ruts in the cultivated soil that can have a negative effect on subsequent sowing operations. At the same time, part of the weight of the chassis is transmitted to the additional soil cultivation device and improves its effect advantageously. If the soil cultivation implement is now raised by the towing vehicle, the chassis is then lowered onto the ground through the action of the articulated quadruple link. At the same time, the additional soil cultivation device is raised above the ground via the multipart connection element, which connects the chassis with the additional soil cultivation device, and in this way enables a turning manoeuvre on the field or transport on the road. The weight of the additional soil cultivation device is supported here on the ground through the chassis and its running wheel and reduces the towing machine's lifting power requirement and the amount of weight that is taken off its front axle. The steering capability of the group consisting of the towing machine and the soil cultivation implement is improved or maintained. An additional hydraulic cylinder to operate the chassis is no longer required. The pressure on the machine operator is also relieved, because, apart from the lifting gear, he does not have to operate any additional elements for the lifting process.

The connection element is located between the chassis and the additional soil cultivation device, whereby it is advisable in concrete terms if the connection element is positioned between the frame of the additional soil cultivation implement and the chassis frame, namely most expediently at least approximately in the centre of the frame of the additional soil cultivation device.

With regard to the design of the connection element, a preferred embodiment of the invention provides for the connection element to be designed as a transmission coupler. The length of this multipart can be movable, elastic or multipart. It is envisaged in particular that a transmission coupler designed as a quadruple link coupler serves as the transmission mechanism. This transmission arrangement enables optimum distribution of the weights, for example if, on contact of the soil cultivation tools of the additional frame with the ground, the base frame with its deadweight is enabled to raise the chassis with its running wheel above the ground.

It was already mentioned that the pivoting or swivel-mounted bearing of chassis and additional soil cultivation device on the base frame leads to the formation of an advantageous quadruple link. With this in mind it is provided that the base frame, the frame, the chassis frame and the connection element form an articulated quadruple link, that therefore the connection element in accordance with the invention is integrated in the quadruple link. The hinged design and/or arrangement of the connection element proves therefore to be particularly advantageous in this context.

For the construction of the multipart connection element or link, the design is for the connection element to have a bracket assigned to the frame and a bracket assigned to the chassis frame, whereby the two brackets are connected to one another by at least one means of connection, for example, bolts or screws. In this way, a quadruple link coupler is formed via the base frame with its articulation points, the frame of the additional soil cultivation device and the chassis frame with its respective brackets and the means of connection.

It is provided in addition in accordance with the invention that at least one running wheel is arranged steerable or rotatable to the chassis frame. In this way, after-running of the running wheel on bends is enabled that leaves less deep ruts in the soil during turning on the field and in accordance with reduces the mechanical load on the chassis frame and the adjacent components. This is given, for example, be designing the running wheel as a so-called tail wheel. Other passive or active steering systems are conceivable as well.

In a further embodiment, the chassis is designed to be lockable in its movement towards the base frame through additional means. In this way, the mobility of the quadruple link is restricted, but, in particular in difficult soil conditions, a part of the weight of the chassis can be transmitted to the base frame and to the soil cultivation tools that are fastened on this, in order to improve their effect as well. During transport journeys, this locking mechanism can be unlocked again. The relief on the front axle of the tractor is restored.

In accordance with a further expedient variant, means for limiting the mobility of the additional soil cultivation device are provided that are designed to be adjustable in one or more working directions through external power. The mobility of the additional soil cultivation device can be easily restricted through the use of actuators.

A variable working depth setting of the front soil cultivation tools is achieved in this way. At the same time, additional weight of the complete soil cultivation implement can be transmitted variably to the chassis in this way. This is advantageous if particularly light or particularly heavy towing vehicles are used, in order not to exceed their permissible axle loads. The weight transmission of the chassis to the front base frame or the additional soil cultivation implement can also be stipulated variably.

In a further design, the chassis frame is formed preferably as a single-arm or from a single jib. This results in a particularly low cost and lean construction. In particular, attaching a tail wheel bearing is possible here in a stable and simple way.

The object of a further advantageous embodiment is that the soil cultivation implement can be hinged or changed from a larger width in the working position to a narrower width in the transport position and vice versa. Soil cultivation implements with particularly large working widths that are over a multiple of the transport width are usually designed as towed, attached vehicles. Here, the advantages of an attached appliance with regard to costs, manageability and manoeuvrability are combined with enhanced performance.

In another embodiment, the additional soil cultivation implement consists of several segments, whereby at least one additional crosspiece is assigned to the segments and/or the chassis that connects the segments of the additional soil cultivation implement and the chassis to each other at least indirectly. If the working width of the additional soil cultivation implement is divided, the individual segments enable better adaptation to the ground, in particular with a bearing that can be rotated in a lengthways direction. Through the addition of a crosspiece, which acts as a connection element or link or contains further connection elements, the weight of the individual segments can be transmitted together to the chassis or the weight of the chassis can be supported evenly on the individual segments.

According to a special embodiment, an additional carrier vehicle fitted with a lifting device is assigned to the soil cultivation implement. Powerful towing vehicles in particular, such as caterpillar or articulated tractors, do not always have their own or a suitable lifting device. Through the use of an additional carrier vehicle with a lifting device the soil cultivation implement in accordance with the invention can be used with these towing vehicles as well. It is even possible here to arrange several such soil cultivation implements in parallel. The negative support load on the towing vehicle generated when the appliances are lifted onto the carrier vehicle is considerably reduced through the invention.

Further details can be seen in the figures and in the following description of the figures:

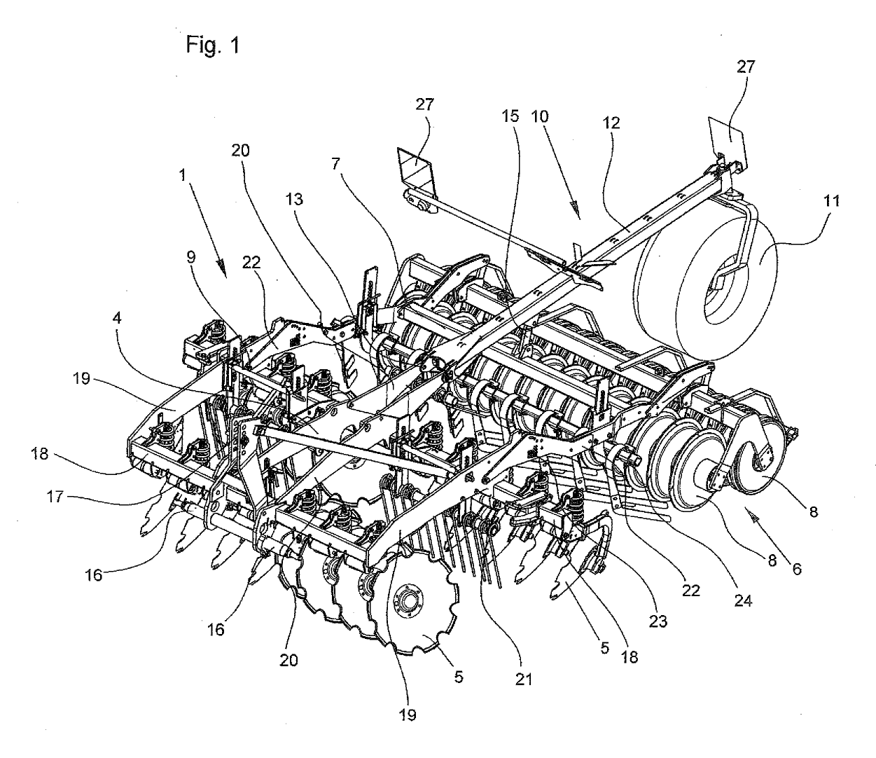

FIG. 1 shows a soil cultivation implement in perspective

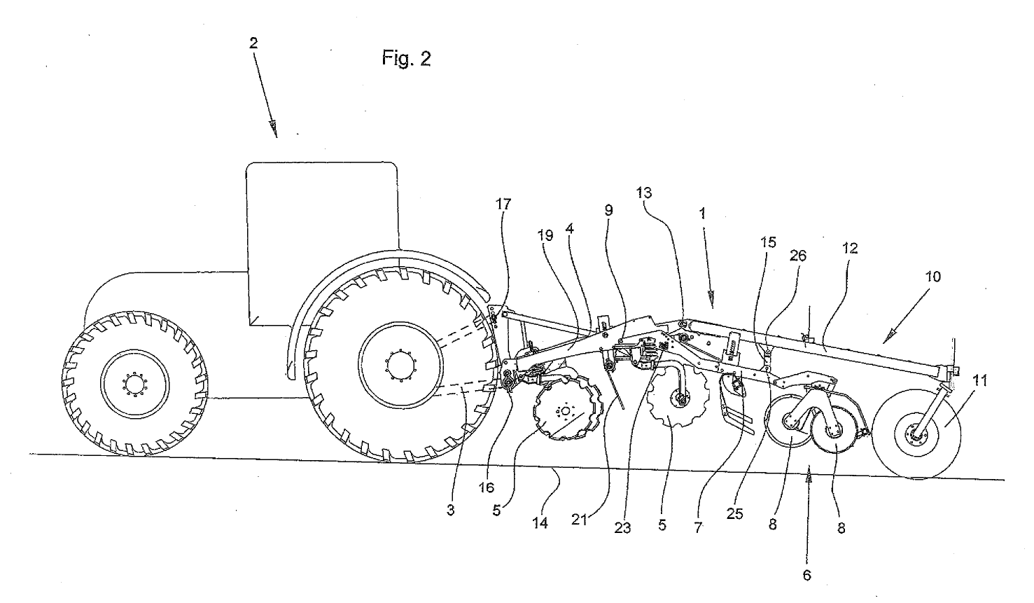

FIG. 2 shows a towing vehicle with a soil cultivation implement in a raised position, and

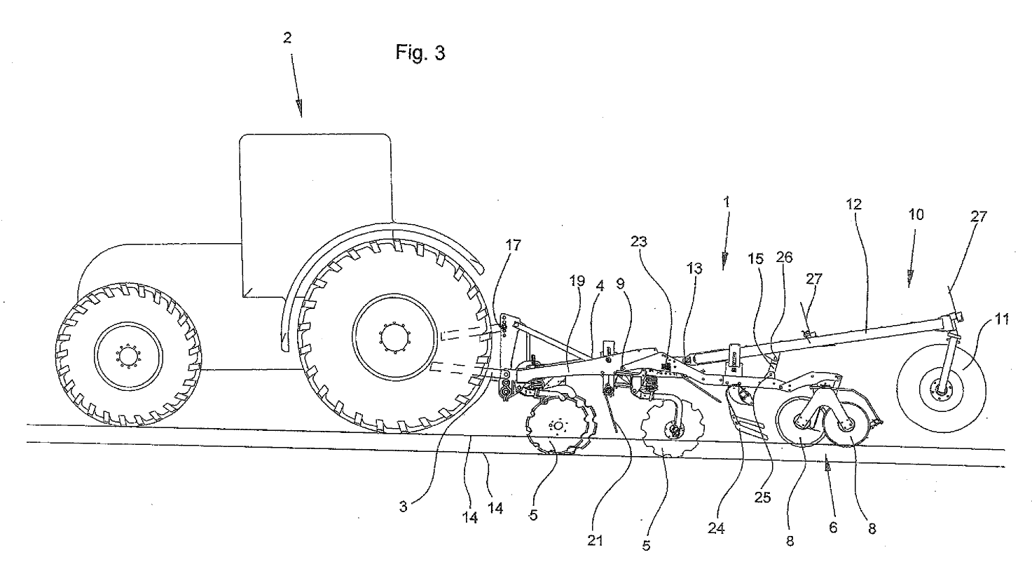

FIG. 3 shows a towing vehicle with a soil cultivation implement in a side view

FIG. 1 shows a soil cultivation implement that is connected to the lifting device 3 of the towing vehicle 2 through the coupling points 16 and 17. The details of the lifting device 4 and the coupling points 16, 17 are described in the standard ISO 730. The coupling points are components of the base frame 4, which, along with other components, consists of cross beams 18 and internal and external longitudinal beams 19, 20. The soil cultivation tools are fixed on the cross beams in one or more rows positioned adjacent to one another. The soil cultivation tools are designed here as rotatable hollow discs that cut into the ground. Other share and tine tools are conceivable. Overload security for the tools can be shown as a shear-off safety device or flexible. A height adjustable holding-down device 21 leads the flow of earth thrown up during work by the soil cultivation tools 5 back in front of the following soil cultivation tools. The additional soil cultivation implement 6 is rotatable over the frame 7 with its side arms 22 at the articulation points 9 rotatable and height adjustable, and is fastened with the external longitudinal beams 19 of the base frame 4 using bolt, screw or other bearing connections. By means of a hole pattern 23 in the side arms 22 of the frame 7 and appropriate recesses or stops on the longitudinal beams 19, the height and the mobility of the additional soil cultivation implement 6 can be set or restricted in one or both directions using pins, screws or bolts. Further levelling elements 24 are attached to the side arms 22 of the additional soil cultivation implement 6 and are height-adjustable and can be moved together with the implement. The additional soil cultivation implement 6 itself consists, for example, of several interlocking soil cultivation tools 8, which are supported here as rotatable rollers on the frame 7 with suitable roller bearings and are used to compact the soil 14 loosened by the soil cultivation tools 5.

Other levelling and shredding tools are conceivable, which can also be replaced as a subunit for example by means of quick-change systems or quick couplings. The soil cultivation tools can also be driven by external power. What is meant here as well are soil cultivation implements for inserting fertiliser, seeds or other agricultural materials into the soil. Above the additional soil cultivation device 6 the chassis 10 is positioned with its chassis frame 12 rotatable at the articulation point, which consists of a pin joint connection and the appropriate bearing holes, which are provided at the rear end of the centre longitudinal beams 20 as well as at the front part of the chassis frame 12. This makes the chassis frame 12 height adjustable. A running wheel 11 in the form of a tail wheel familiar to persons skilled in the art is attached the other end of the chassis frame 12. The tail wheel can rotate freely around a vertical axis and on contact with the ground adjusts its direction of travel automatically to the direction of travel of the towing vehicle. Two brackets 26 are fixed to the first third of the chassis frame. Underneath these brackets 26 two additional brackets 25 are fixed approximately in the centre of the frame 7 of the additional soil cultivation device 6. A connection element or link 15 in the form of a transmission coupler connects these brackets by means of bolts or screws free rotating. The transmission coupler can be designed in its length to be movable, elastic or multipart. This results through base frame 4 with its articulation points 9 and 13, frame 7 with its brackets 25, chassis frame 12 with its brackets 26 and connection element 15 in a quadruple link coupler as transmission mechanism. Through this transmission layout, the base frame with its deadweight is able, on contact of the soil cultivation tools 8 with the ground 14 to raise chassis 10 with its running wheel 11 above the ground. If the soil cultivation implement 1 is now lifted by the lifting device 3 of the towing vehicle 2, the soil cultivation tools 8 lose contact with the ground 9. The chassis 10 with its running wheel 11 is lowered to the ground and supports a large part of the weight of the additional soil cultivation device through connection element 15. The lifting power requirement of the lifting device and the axle load of the towing vehicle 2 are improved in this way. For better visibility during road transport the chassis is fitted with warning signs 27 and lights attached to these. In FIG. 1, a warning sign 27 is omitted to show the running wheel 11.

In FIG. 2, the towing machine 2 has lifted the soil cultivation implement with its lifting device 3. The chassis 10 maintains contact with the ground 14 through its running wheel 11. It can be clearly seen that the weight of the additional soil cultivation device 6 is transmitted via the multipart connection element 15 to the chassis frame 12 and the running wheel 11. Only part of the weight is transmitted via the articulation point 13 to the base frame 4. The additional soil cultivation device 6 now has sufficient ground clearance for travelling on roads and for turning.

In contrast to FIG. 2, FIG. 3 shows the lowered state. The front soil cultivation tools 5 till, mix and loosen the soil. The following levelling elements 24 level the earth that is thrown up. The loosened soil 14 is compacted again by the additional soil cultivation device 6 with its rolling soil cultivation tools 8, in order to guarantee a sufficient capillary effect for the following seed. The chassis 10 is displaced upwards through the connection element or link 15, the running wheel 11 is no longer in contact with the ground and does not cause any ruts of the running wheel 11 that disturb subsequent work. In addition, the weight of the chassis 10 is transmitted to the additional soil cultivation device 6 thus improving the effect.

1. Soil cultivation implement (1) that is planned to be attached to a lifting device (3) of a towing vehicle (2) and is connected to the lifting device (3) of the towing vehicle (2) through the coupling points (16, 17), whereby the soil cultivation implement (1) is equipped with a base frame (4) and soil cultivation tools (5) arranged on this, whereby at least one additional soil cultivation device (6) consisting of an additional frame (7) and soil cultivation tools (8) arranged on this is planned for the base frame (4), whereby the additional soil cultivation device (6) is arranged to be lifted with regard to the base frame (4) by at least one articulation point (9), whereby the mobility can be restricted by limitation means, wherein at least one chassis (10), consisting at least of one running wheel (11) and at least of one chassis frame (12), is also arranged to be height adjustable with regard to the base frame (4) through at least one articulation point (13), whereby in a lowered position the soil cultivation tools (5) and the additional soil cultivation device (6) are in operative connection with the ground (14) and in a raised position are lifted above the ground (14), whereby the chassis (10) is connected with the additional soil cultivation device (6) with at least one connection element (15), whereby in a raised position of the soil cultivation implement (1) to the towing vehicle (2) the at least one connection element (15) is designed or arranged to transmit a part of the weight of the additional soil cultivation device (6) to the chassis (10) towards the ground (14) and the other part of the weight to the base frame (4), and in a lowered position of the soil cultivation implement (1) towards the towing vehicle (2) a part of the weight of the chassis (10) to the additional soil cultivation device (6) towards the ground (9).

2. Soil cultivation implement in accordance with claim 1, wherein the connection element (15) is positioned between the frame (7) of the additional soil cultivation device (6) and the chassis frame (12).

3. Soil cultivation implement in accordance with claim 1, wherein the connection element (15) is designed as a transmission coupler.

4. Soil cultivation implement in accordance with claim 3, wherein the base frame (4), the frame (7), the chassis frame (12) and the connection element (15) form an articulated quadruple link.

5. Soil cultivation implement in accordance with claim 1, wherein the connection element (15) has a bracket (25) assigned to the frame (7) and a bracket (26) assigned to the chassis frame (12), whereby the two brackets (25, 26) are connected to one another by means of at least one connecting means.

6. Soil cultivation implement in accordance with claim 1, wherein at least one running wheel (11) as arranged to be steerable or rotatable towards the chassis frame (12).

7. Soil cultivation implement in accordance with claim 1, wherein the chassis (10) is designed to be lockable in its movement towards the base frame (4) by additional means.

8. Soil cultivation implement in accordance with claim 1, wherein means are provided to limit the mobility of the additional soil cultivation device (6) that are designed to be adjustable in one or more working directions by external power.

9. Soil cultivation implement in accordance with claim 1, wherein the chassis frame (12) is designed preferably as a single arm or consisting of a single jib.

10. Soil cultivation implement in accordance with claim 1, wherein the soil cultivation implement (1) can be folded or altered from a larger width in the working position to a smaller width in the transport position and vice versa.

11. Soil cultivation implement in accordance with claim 1, wherein the additional soil cultivation implement (6) consists of several segments, whereby at least one additional crosspiece is assigned to the segments and/or the chassis (10) that connects the segments of the additional soil cultivation implement (6) and the chassis (10) to each other at least indirectly.

12. Soil cultivation implement in accordance with claim 1, wherein an additional carrier vehicle, which is equipped with a lifting device, is assigned to the soil cultivation implement.
